(19) United States
(12) Patent Application Publication
(10) Pub. No.: US 2023/0069197 A1
(43) Pub. Date: Mar. 2, 2023

(54) METHOD, APPARATUS, DEVICE AND STORAGE MEDIUM FOR TRAINING VIDEO RECOGNITION MODEL

(71) Applicant: Beijing Baidu Netcom Science Technology Co., Ltd., Beijing (CN)

(72) Inventors: Wenhao WU, Beijing (CN); Yuxiang Zhao, Beijing (CN)

(21) Appl. No.: 17/983,208

(22) Filed: Nov. 8, 2022

Related U.S. Application Data
(63) Continuation of application No. PCT/CN2022/075153, filed on Jan. 30, 2022.

(30) Foreign Application Priority Data
May 28, 2021 (CN) 202110589375.6

(51) Int. Cl. G06V 10/82; G06V 10/44; G06V 10/80; G06V 20/40; G06V 20/70; H04N 19/132

(52) U.S. Cl. CPC G06V 10/82; G06V 10/44; G06V 10/806; G06V 20/49; G06V 20/70; H04N 19/132

(57) ABSTRACT

A method and an apparatus for training a video recognition model are provided. The method may include: dividing a sample video into a plurality of sample video segments; sampling a part of sample video frames from a sample video segment; inputting the part of sample video frames into a feature extraction network to obtain feature information of the sample video segment; performing convolution fusion on the feature information by using a dynamic segment fusion module to obtain fusion feature information, where a convolution kernel of the dynamic segment fusion module varies with different video inputs; inputting the fusion feature information to a fully connected layer to obtain an estimated category of the sample video; and performing a parameter adjustment based on a difference between the tag of a true category and the estimated category to obtain the video recognition model.

### CROSS-REFERENCE TO RELATED APPLICATIONS

The present application is a continuation of International Application No. PCT/CN2022/075153, filed on Jan. 30, 2022, which claims the priority of Chinese Patent Application No. 202110589375.6, titled “METHOD, APPARATUS, DEVICE AND STORAGE MEDIUM FOR TRAINING VIDEO RECOGNITION MODEL”, filed on May 28, 2021. The content of these applications are incorporated herein by reference in their entireties.

### TECHNICAL FIELD

The present disclosure relates to the field of artificial intelligence, particularly to the field of computer vision and deep learning, applicable in video analysis scenarios.

### BACKGROUND

Video recognition is to input a video and classify the video based on the content of the video. Video recognition is one of the most active research topics in computer vision communities. Two of the most important aspects of evaluating video recognition methods are classification accuracy and cost for reasoning. Recently, a recognition accuracy of video recognition has achieved great success, but it remains a challenging task due to the large computational cost.

Currently, for deep learning-related methods, work to improve the recognition accuracy of video recognition is mainly focused on designing a network structure used to capture higher-order action semantics. Video frames input to a network are obtained by even sampling or random sampling at intervals of the video. Obtained results of video segments are averaged during the reasoning process.

### SUMMARY

The present disclosure provides specifically to a method, an apparatus, a device, a storage medium and a program product for training a video recognition model.

According to a first aspect of the present disclosure, a method for training a video recognition model is provided, which includes: dividing a sample video into a plurality of sample video segments, wherein the sample video is labeled with a tag of a true category; sampling a part of sample video frames from a sample video segment; inputting the part of sample video frames into a feature extraction network to obtain feature information of the sample video segment; performing convolution fusion on the feature information by using a dynamic segment fusion module to obtain fusion feature information, wherein a convolution kernel of the dynamic segment fusion module varies with different video inputs; inputting the fusion feature information to a fully connected layer to obtain an estimated category of the sample video; and performing a parameter adjustment based on a difference between the tag of the true category and the estimated category to obtain the video recognition model.

According to a second aspect of the present disclosure, an electronic device is provided, which includes: one or more processors; and a storage device in communication with one or more processor, where the storage device stores instructions executable by the one or more processor, to enable the one or more processor to perform the method described in any of implementations of the first aspect, or to perform the method described in any of implementations of the second aspect.

According to a third aspect of the present disclosure, a non-transitory computer readable storage medium storing a computer instruction is provided, where the computer instruction when executed by a computer causes the computer to perform the method described in any of implementations of the first aspect.

It should be understood that the content described in this section is not intended to identify key or important features of the embodiments of the present disclosure, nor is it intended to limit the scope of the present disclosure. Other features of the present disclosure will become readily understood from the following specification.

### BRIEF DESCRIPTION OF THE DRAWINGS

Other features, objectives and advantages of the present disclosure will become more apparent upon reading the detailed description of non-limiting embodiment with reference to the following accompanying drawings. The accompanying drawings are used for a better understanding of the scheme, and do not constitute a limitation to the present disclosure. Here:

FIG. 1 is a flowchart of a method for training a video recognition model according to some embodiments of the present disclosure.

FIG. 2 is a flowchart of another method for training a video recognition model according to some embodiments of the present disclosure.

FIG. 3 is a scenario diagram of a method for training a video recognition model adapted to implement embodiments of the present disclosure.

FIG. 4 is a schematic structural diagram of the video recognition model.

FIG. 5 is a schematic structural diagram of a dynamic segment fusion (DSA) block.

FIG. 6 is a flowchart of video recognition method according to some embodiments of the present disclosure.

FIG. 7 is a schematic structural diagram of an apparatus for training a video recognition model according to some embodiments of the present disclosure.

FIG. 8 is a schematic structural diagram of a video recognition apparatus according to some embodiments of the present disclosure.

FIG. 9 is a schematic structural diagram of an electronic device adapted to implement a method for training a video recognition model or a video recognition method according to some embodiments of the present disclosure.

### DETAILED DESCRIPTION OF EMBODIMENTS

Example embodiments of the present disclosure are described below with reference to the accompanying drawings, where various details of the embodiments of the present disclosure are included to facilitate understanding and should be considered merely as examples. Therefore, those of ordinary skills in the art should realize that various changes and modifications can be made to the embodiments described herein without departing from the scope and spirit of the present disclosure. Similarly, for clearness and conciseness, descriptions of well-known functions and structures are omitted in the following description.

It should be noted that the embodiments of the present disclosure and features of the embodiments may be combined with each other on a non-conflict basis. The present disclosure will be described below in detail with reference to the accompanying drawings and in combination with the embodiments.

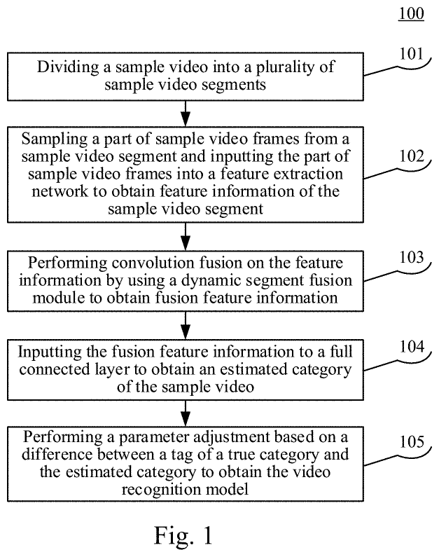

FIG. 1 illustrates a flow 100 of a method for training a video recognition model according to some embodiments of the present disclosure. The method for training a video recognition model may include the following steps.

Step 101 includes dividing a sample video into a plurality of sample video segments.

In this embodiment, an executing body of the method for training a video recognition model may acquire a sample video set. For a sample video in the sample video set, the above-described executing body may divide the sample video into a plurality of sample video segments.

The sample video set may include a large number of sample videos labeled with tags of true categories. The tags of the true categories may be obtained by classifying the sample videos with other video recognition models, or be obtained by classifying the sample videos manually, which is not limited herein.

Here, a sample video may be divided into sample video segments in a variety of ways. For example, the sample video is evenly divided according to a video length to obtain a plurality of sample video segments of a same length. For another example, the sample video is divided according to a fixed length to obtain a plurality of sample video segments of the fixed length. For yet another example, the sample video is randomly divided to obtain a plurality of sample video segments of a random length.

Step 102 includes sampling a part of sample video frames from a sample video segment and inputting the part of sample video frames into a feature extraction network to obtain feature information of the sample video segment.

In this embodiment, fora sample video segment of a plurality of sample video segments, the above-described executing body may sample a part of sample video frames from the sample video segment and input the part of sample video frames into a feature extraction network to obtain feature information of the sample video segment. Only the part of the sample video frames is sampled, and are input to the feature extraction network to extract features, which may reduce training workload and shorten training time.

The feature extraction network may be used to extract features from a video and may include but not limited to various neural networks for feature extraction, such as a convolutional neural network (CNN).

Here, the part of the sample video frames may be sampled from the sample video segment in a variety of ways.

For example, video frames are sampled from the sample video segment at equal intervals to obtain a plurality of evenly spaced sample video frames. For another example, the sample video segment is randomly sampled to obtain a plurality of randomly spaced sample video frames.

Step 103 includes performing convolution fusion on the feature information by using a dynamic segment fusion module to obtain fusion feature information.

In this embodiment, the above-mentioned executing body may use a dynamic segment fusion module to obtain fusion feature information.

A convolution kernel of the dynamic segment fusion module may vary with different video inputs. For differences in the feature information of different videos, especially in feature channels, the dynamic segment fusion module generates a dynamic convolution kernel.

The convolution kernel of the dynamic segment fusion module may vary with different video inputs and is associated with an input channel. The convolution kernel of the dynamic segment fusion module may perform convolution fusion on the pieces of feature information of video segments of a video by using a dynamic segment fusion module to obtain fusion feature information, thereby realizing perception and modeling of a long-time domain of the video.

Generally, a video recognition model may include a plurality of residual layers, and a dynamic segment fusion module may be arranged inside a residual layer. In practice, when more dynamic segment fusion modules are arranged, more fusions are performed, and the recognition accuracy is higher, but more calculation is performed. Therefore, the number of dynamic segment fusion modules may be determined by considering requirements of recognition accuracy and calculation amount. Alternatively, at least one dynamic segment fusion module may be arranged in the plurality of residual layers of the video recognition model and arranged at an interval of a residual layer. For example, the video recognition model may include residual layers Res2, Res3, Res4, and Res5. Two dynamic segment fusion modules are arranged inside residual layer Res3 and residual layer Res5, respectively.

Step 104 includes inputting the fusion feature information to a fully connected layer to obtain an estimated category of the sample video.

In this embodiment, the above-mentioned executing body may input the fusion feature information to a fully connected layer for classification, and an estimated category of the sample video is obtained. The fully connected layer may output a score of the sample video belonging to each pre-set category.

Step 105 includes performing a parameter adjustment based on a difference between the tag of the true category and the estimated category to obtain the video recognition model.

In this embodiment, the above-mentioned executing body may perform a parameter adjustment based on a difference between the tag of the true category and the estimated category to obtain the video recognition model. A purpose of parameter adjustment is to make the difference between a tag of the true category and the estimated category as small as possible.

In some alternative implementations of this embodiment, the executing body may first calculate a cross entropy loss based on the tag of the true category and the estimated category, then optimize the cross-entropy loss by using a stochastic gradient descent (SGD) and continuously update parameters until the cross entropy loss converges to obtain the video recognition model.

According to the method for training the video recognition model provided in some embodiments of the present disclosure, by designing the dynamic segment fusion module, a convolution kernel of the video recognition model may vary with different video inputs in training and reasoning processes, thereby improving a recognition accuracy. The video recognition model adopts a recognition method of dynamic convolution fusion, and parameters of convolution kernel for fusing segments may vary with different video inputs, so that a time domain perception which is more accurate than using only one convolution kernel is realized, and the recognition accuracy is improved without increasing a computational complexity. In particular, a recognition accuracy of a long video with longer and richer information may be improved. The method is applicable for medium and long video classification, movie and TV play content classification, and the like.

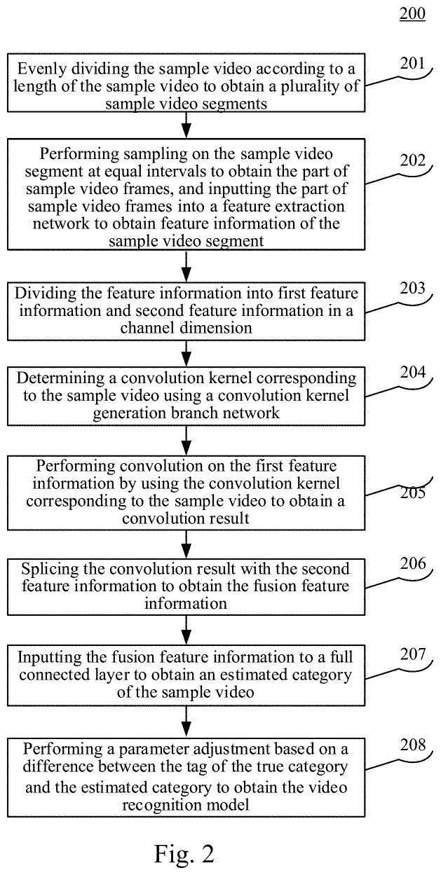

Further referring to FIG. 2, FIG. 2 illustrates a flow 200 of another method for training a video recognition model according to some embodiments of the present disclosure. The alternate method for training the video recognition model may include the following steps.

Step 201 includes evenly dividing the sample video according to a length of the sample video to obtain the plurality of sample video segments.

In this embodiment, an executing body of the method for training a video recognition model may acquire a sample video set. For a sample video in the sample video set, the above-described executing body may evenly divide the sample video according to a length of the sample video to obtain the plurality of sample video segments. For example, for a 10-second sample video, the video is divided evenly at a video interval of two seconds to get five 2-second sample video segments.

The sample video set may include a large number of sample videos labeled with tags of true categories. The tags of true categories may be obtained by classifying the sample videos with other video recognition models, or be obtained by classifying the sample videos manually, which is not limited herein.

Step 202 includes sampling is performed on the sample video segment at equal intervals to obtain the part of sample video frames.

In this embodiment, for a sample video segment of a plurality of sample video segments, the above-described executing body may perform sampling on the sample video segment at equal intervals to obtain a part of sample video frames and input the part of sample video frames into a feature extraction network to obtain feature information of the sample video segment. Only the part of the sample video frames are sampled, and are input to the feature extraction network to extract features, which may reduce training workload and shorten training time. For example, for a 2-second sample video segment, eight sample video frames can be obtained by sampling on the video segment at equal intervals of 0.25 seconds.

The feature extraction network may be used to extract features from a video, and may include but not limited to various neural networks for feature extraction, such as a convolutional neural network (CNN).

Here, the sample video is evenly divided according to the length of the sample video, and then sampling is performed on a divided sample video segment at equal intervals, so that the feature extraction network may extract the feature information of positions of the sample video.

Step 203 includes dividing the feature information into first feature information and second feature information in a channel dimension.

In this embodiment, the above-mentioned executing body may divide the feature information into first feature information and second feature information in a channel dimension. The first feature information and the second feature information correspond to different channel dimensions.

In some alternative implementations of this embodiment, the above-mentioned executing body may divide the feature information into the first feature information and the second feature information in the channel dimension according to a pre-set hyper-parameter β, where a channel dimension of the first feature information is βC, a channel dimension of the second feature information is (1−β)C, and C is the channel dimension of the feature information. β is a hyper-parameter, a value of which ranges from 0 to 1.

Since a convolution operation needs to be performed on the first feature information and only a spicing operation is performed on the second feature information, calculation amount of the convolution operation may be controlled by adjusting the hyper-parameter β. Generally, the value of the hyper-parameter ranges from 0 to 0.5, and the calculation amount of the convolution operation may be reduced.

Step 204 includes determining a convolution kernel corresponding to the sample video using a convolution kernel generation branch network.

In this embodiment, the above-mentioned executing body may determine a convolution kernel corresponding to the sample video using a convolution kernel generation branch network.

Dynamic segment fusion (DSA) module may include a convolution kernel generation branch network. The convolution kernel generation branch network may be used to generate a convolution kernel. The convolution kernel may vary with different video inputs.

In some alternative implementations of this embodiment, the above-mentioned executing body may first calculate a product βC×U×T×H×W of a channel dimension 0 C of the first feature information, a number U of the plurality of sample video segments, a number T of the part of sample video frames of the sample video segment and a height H and a width W of the sample video frame, and then input the product βC×U×T×H×W to the convolution kernel generation branch network to quickly obtain the convolution kernel corresponding to the sample video. The convolution kernel generation branch network may include a global average pooling (GAP) and two fully connected (FC)layers.

Step 205 includes performing convolution on the first feature information by using the convolution kernel corresponding to the sample video to obtain a convolution result.

In this embodiment, the above-mentioned executing body may perform convolution on the first feature information by using the convolution kernel corresponding to the sample video to obtain a convolution result.

Step 206 includes splicing the convolution result with the second feature information to obtain the fusion feature information.

In this embodiment, the above-mentioned executing body may splice the convolution result with the second feature information to obtain the fusion feature information. Dividing the feature information into first feature information and second feature information in a channel dimension, performing convolution on the first feature information and splicing the convolution result with the second feature information to obtain the fusion feature information may reduce calculation amount of the convolution operation.

Step 207 includes inputting the fusion feature information to a fully connected layer to obtain an estimated category of the sample video.

Step 208 includes performing a parameter adjustment based on a difference between the tag of the true category and the estimated category to obtain the video recognition model.

In this embodiment, steps 207 to 208 are already described in detail in steps 104 to 105 in the embodiment shown in FIG. 1, which is not described herein.

As is shown in FIG. 2, the method for training the video recognition model in this embodiment highlights a video division step, a video frame sampling step, and a convolution fusion step, as compared to the corresponding embodiment of FIG. 1.

Here, according to the solution described in this embodiment, the sample video is evenly divided according to the length of the sample video, and then sampling is performed on a divided sample video segment at equal intervals, so that the feature extraction network may extract the feature information of positions of the sample video. Dividing the feature information into first feature information and second feature information in a channel dimension, performing convolution on the first feature information and splicing the convolution result with the second feature information to obtain the fusion feature information may reduce calculation amount of the convolution operation.

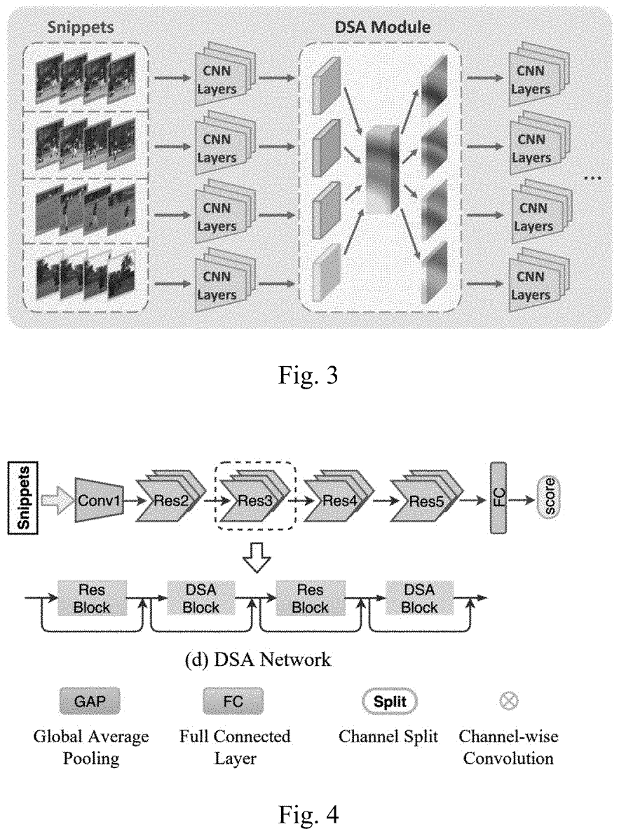

Further referring to FIG. 3, FIG. 3 illustrates a scenario diagram of a method for training a video recognition model adapted to implement embodiments of the present disclosure. As shown in FIG. 3, the sample video is evenly divided into four sample video segments (snippets), and four video frames are sampled at equal intervals from each sample video segment. The four video frames of each sample video segment are input to a corresponding CNN Layer to obtain feature information of the four sample video segments. The DSA Module is used to perform convolution fusion on the feature information of the four sample video segments to obtain fusion feature information, and then the obtained fusion feature information are inputted into CNN layers for processing.

Further referring to FIG. 4, FIG. 4 illustrates a schematic structural diagram of video recognition model. As is shown in FIG. 4, the video recognition model may include a convolutional layer, a plurality of residual layers, and a fully connected layer, and dynamic segment fusion modules may be arranged in a plurality of residual layers and at an interval of a residual layer. Specifically, the video recognition model includes convolution layer Convl, residual layer Res2, residual layer Res3, residual layer Res4, residual layer Res5, and fully connected layer FC. The segments of the sample video are processed by Convl, Res2, Res3, Res4, Res5 and FC to obtain an estimated category (score belonging to each pre-set category) of the sample video. Two dynamic segment fusion modules are arranged inside the Res3 and the Res5 respectively. FIG. 4 only shows a structure of Res3, including two Res Blocks and two DSA Blocks. A structure of Res5 is the same as that of Res3 and not shown in FIG. 3.

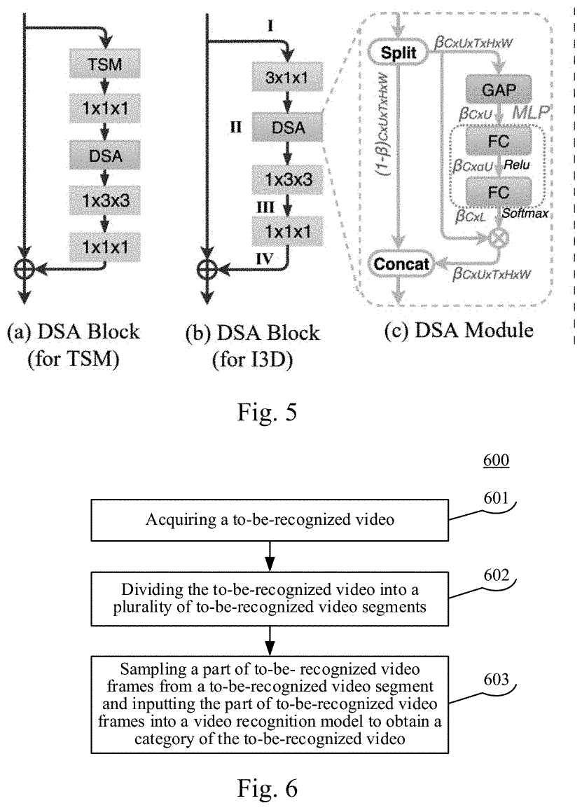

Further referring to FIG. 5, FIG. 5 illustrates a schematic structural diagram of a DSA Block. FIG. 5 illustrates two kinds of DSA Block. Figure(a) in FIG. 5 shows one DSA Block (for TSM), which is a 2D DSA Block. Figure (b) in FIG. 5 shows another DSA Block (for I3D), which is a 3D DSA Block. Figure (c)in Fig.5 shows schematic structural diagrams of DSA Modules in the DSA Block for TSM and the DSA Block for I3D. The DSA Module includes a GAP and two FCs. The feature information is divided into first feature information βC and second feature information (1−β) C in a channel dimension. The product βC×U×T×H×W is input to the GAP to obtain βC×U. βC×U is input to FC to obtain βC×aU. βC×aU is input to FC to obtain βC×L. βC×L is convoluted with C×U×T×H×W and spliced with (1−β) C×U×T×H×W.

Further referring to FIG. 6, FIG. 6 illustrates a flowchart of video recognition method according to some embodiments of the present disclosure. The video recognition method may include the following steps.

Step 601 includes acquiring a to-be-recognized video.

In this embodiment, the executing body of the video recognition method may acquire a to-be-recognized video.

Step 602 includes dividing the to-be-recognized video into a plurality of to-be-recognized video segments.

In this embodiment, the above-mentioned executing body may divide the to-be-recognized video into a plurality of to-be-recognized video segments.

Here, a method for dividing the to-be-recognized video may refer to a method for dividing the sample video, which is not described herein.

In some alternative implementations of this embodiment, a dividing granularity of the to-be-recognized video is greater than a dividing granularity of the sample video. A number of sample videos used to train the video recognition model is large, and a training time may be shortened by reducing the dividing granularity of a sample videos. A recognition accuracy may be improved by increasing the dividing granularity of the to-be-recognized video. For example, for a 10-second sample video, the video is divided evenly at a video interval of two seconds to get five 2-second sample video segments. For a 10-second to-be-recognized video, the video is divided evenly at a video interval of one second to get ten 2-second to-be-recognized video segments.

Step 603 includes sampling a part of to-be-recognized video frames from a to-be-recognized video segment and inputting the part of to-be-recognized video frames into a video recognition model to obtain a category of the to-be-recognized video.

In this embodiment, the above-mentioned executing body may sample a part of to-be-recognized video frames from a to-be-recognized video segment, input the part of to-be-recognized video frames into a video recognition model for estimation, and aggregate estimated results to obtain a category of the to-be-recognized video.

Here, a method for sampling the to-be-recognized video segment may be referred to a method for sampling the sample video segment, which is not described herein. The video recognition model may be used for video classification, and is obtained by using a training method according to any one implementation in FIGS. 1 to 2, which is not described herein.

According to the video recognition method, provided in some embodiments of the present disclosure, an efficient video recognition method based on dynamic segment fusion is provided. By designing the dynamic segment fusion module, a convolution kernel of the video recognition model may vary with different video inputs in training and reasoning processes, thereby improving a recognition accuracy. The video recognition model adopts a recognition method of dynamic convolution fusion, and parameters of convolution kernel for fusing segments may vary with different video inputs, so that a time domain perception which is more accurate than using only one convolution kernel is realized, and the recognition accuracy is improved without increasing a computational complexity. In particular, a recognition accuracy of a long video with longer and richer information may be improved. It can be used for medium and long video classification, movie and TV play content classification, and the like.

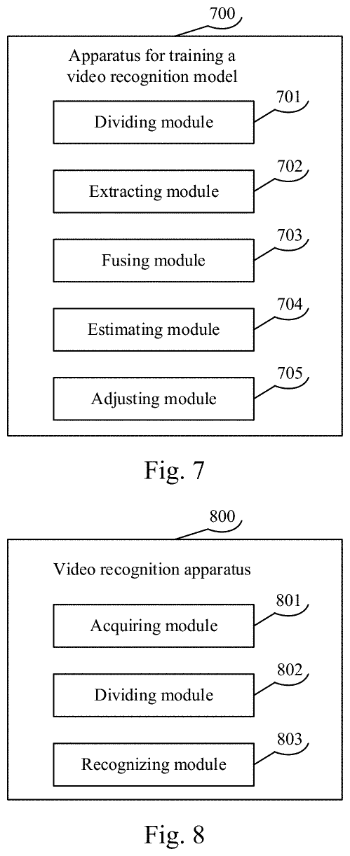

Further referring to FIG. 7, as an implementation of the method shown in each of the above-mentioned figures, an embodiment of an apparatus for training a video recognition model is provided in the present disclosure. The embodiment of the apparatus corresponds to the embodiment of the method shown in FIG. 1, and the apparatus may be specifically applied to various electronic devices.

As shown in FIG. 7, an apparatus 700 for training a video recognition model provided in this embodiment may include a dividing module 701, an extracting module 702, an fusing module 703, an estimating module 704 and an adjusting module 705.

The dividing module 701 is configured to divide a sample video into a plurality of sample video segments, where the sample video is labeled with a tag of a true category. The extracting module 702 is configured to sample a part of sample video frames from a sample video segment and input the part of sample video frames into a feature extraction network to obtain feature information of the sample video segment. The fusing module 703 is configured to perform convolution fusion on the feature information by using a dynamic segment fusion module to obtain fusion feature information, wherein a convolution kernel of the dynamic segment fusion module varies with different video inputs. The estimating module 704 is configured to input the fusion feature information to a fully connected layer to obtain an estimated category of the sample video. The adjusting module 705 is configured to perform a parameter adjustment based on a difference between the tag of the true category and the estimated category to obtain the video recognition model.

In the apparatus 700 for training a video recognition model provided in this embodiment, specific processing methods and the technical effects of the dividing module 701, the extracting module 702, the fusing module 703, the estimating module 704 and the adjusting module 705, may be respectively referred to the related description of steps 101 to 105 in corresponding embodiments of FIG. 1, which are not described herein.

In some alternative implementations of this embodiment, the fusing module 703 includes a dividing sub-module, configured to divide the feature information into first feature information and second feature information in a channel dimension; a determining sub-module, configured to determine a convolution kernel corresponding to the sample video using a convolution kernel generation branch network; a convoluting sub-module, configured to perform convolution on the first feature information by using the convolution kernel corresponding to the sample video to obtain a convolution result; and a splicing sub-module, configured to splice the convolution result with the second feature information to obtain the fusion feature information.

In some alternative implementations of this embodiment, the dividing sub-module is further configured to: divide the feature information into the first feature information and the second feature information in the channel dimension according to a pre-set hyper-parameter β, where a channel dimension of the first feature information is βC, a channel dimension of the second feature information is (1−β)C, and C is the channel dimension of the feature information.

In some alternative implementations of this embodiment, the determining sub-module is further configured to: calculate a product of the channel dimension βC of the first feature information, a number of the plurality of sample video segments, a number of the part of sample video frames of the sample video segment, and a height and a width of the sample video frame; and input the product to the convolution kernel generation branch network to obtain the convolution kernel corresponding to the sample video.

In some alternative implementations of this embodiment, the convolution kernel generation branch network includes a global average pooling layer and two fully connected layers.

In some alternative implementations of this embodiment, the video recognition model includes a plurality of residual layers, and at least one dynamic segment fusion is arranged in the plurality of residual layers and at an interval of a residual layer.

In some alternative implementations of this embodiment, the dividing module 701 is further configured to: evenly divide the sample video according to a length of the sample video to obtain the plurality of sample video segments. The extracting module 702 is further configured to: sample video frames from the sample video segment at equal intervals to obtain the part of sample video frames.

In some alternative implementations of this embodiment, the adjusting module is further configured to: calculate a cross entropy loss based on the tag of the true category and the estimated category; optimize the cross-entropy loss by using a stochastic gradient descent and continuously updating parameters until the cross-entropy loss converges to obtain the video recognition model.

Further referring to FIG. 8, as an implementation of the method shown in each of the above-mentioned figures, an embodiment of a video recognition apparatus is provided in the present disclosure. The embodiment of the apparatus corresponds to the embodiment of the method shown in FIG. 6, and the apparatus may be specifically applied to various electronic devices.

As shown in FIG. 8, the video recognition apparatus 800 in this embodiment may include: an acquiring module 801, a dividing module 802 and a recognizing module 803. The acquiring module 801 is configured to acquire a to-be-recognized video. The dividing module 802 is configured to divide the to-be-recognized video into a plurality of to-be-recognized video segments. The recognizing module is configured to sample a part of to-be-recognized video frames from a to-be-recognized video segment and input the part of to-be-recognized video frames into a video recognition model to obtain a category of the to-be-recognized video, where the video recognition model is obtained according to the training described in any embodiment in FIGS. 1 to 2.

In the video recognition apparatus 800 in this embodiment, specific processing of: the acquiring module 801, the dividing module 802 and the recognizing module 803, and the technical effects thereof, may be described with reference to the related description of steps 601 to 603 in corresponding embodiments in FIG. 6, which are not described herein.

In some alternative implementations of this embodiment, a dividing granularity of the to-be-recognized video is greater than a dividing granularity of the sample video configured to train the video recognition model.

In the technical solution of the present disclosure, the collection, storage, use, processing, transmission, provision, disclosure, etc. of the personal information of a user all comply with the provisions of the relevant laws and regulations, and do not violate public order and good customs.

According to an embodiment of the present disclosure, the present disclosure further provides an electronic device, a readable storage medium, and a computer program product.

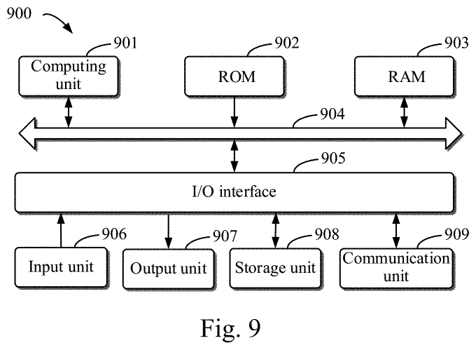

FIG. 9 is a schematic block diagram of an example electronic device 900 that may be adapted to implement the embodiments of the present disclosure. The electronic device is intended to represent various forms of digital computers such as a laptop computer, a desktop computer, a workstation, a personal digital assistant, a server, a blade server, a mainframe computer, and other appropriate computers. The electronic device may alternatively represent various forms of mobile apparatuses such as personal digital assistant, a cellular telephone, a smart phone, a wearable device and other similar computing apparatuses. The parts shown herein, their connections and relationships, and their functions are only as examples, and not intended to limit implementations of the present disclosure as described and/or claimed herein.

As shown in FIG. 9, the device 900 includes a computing unit 901, which can perform various appropriate actions and processes according to a computer program stored in a read only memory (ROM) 902 or a computer program loaded from the storage unit 908 into a random-access memory (RAM) 903. In RAM 903, various programs and data required for the operation of device 900 can also be stored. The computing unit 901, ROM 902, and RAM 903 are connected to each other through a bus 904. Input/output (I/O) interface 905 is also connected to bus 904.

A plurality of components in the device 900 are connected to the I/O interface 905, including: an input unit 906, such as a keyboard, a mouse, etc.; an output unit 907, such as various types of displays, speakers, and the like; a storage unit 908, such as a magnetic disk, an optical disk, and the like; and a communication unit 909, such as a network card, a modem, a wireless communication transceiver, and the like. The communication unit 909 allows the device 900 to exchange information/data with other devices through computer networks such as the Internet and/or various telecommunication networks.

The computing unit 901 may be various general-purpose and/or special-purpose processing components with processing and computing capabilities. Some examples of the computing unit 901 include, but are not limited to, a central processing unit (CPU), a graphics processing unit (GPU), various dedicated artificial intelligence (AI) computing chips, various computing units that run machine learning model algorithms, digital signal processors (DSPS), and any appropriate processors, controllers, microcontrollers, and the like. The calculation unit 901 performs the various methods and processes described above, such as a method for training a video recognition model. For example, in some embodiments, the method for training a video recognition model may be implemented as a computer software program that is tangibly contained in a machine-readable medium, such as a storage unit 908. In some embodiments, part or all of the computer program may be loaded and/or installed on the device 900 via ROM 902 and/or communication unit 909. When the computer program is loaded into RAM 903 and executed by the computing unit 901, one or more steps of the method for training a video recognition model described above may be performed. Alternatively, in other embodiments, the computing unit 901 may be configured to perform the method for training a video recognition model by any other suitable means (e.g., by means of firmware).

Various embodiments of the systems and technologies described above in this paper can be implemented in digital electronic circuit systems, integrated circuit systems, field programmable gate arrays (FPGAs), application specific integrated circuits (ASIC), application specific standard products (ASSP), system on chip (SOC), load programmable logic devices (CPLD), computer hardware, firmware, software, and/or combinations thereof. These various embodiments may include: being implemented in one or more computer programs, the one or more computer programs can be executed and/or interpreted on a programmable system including at least one programmable processor, which can be a special-purpose or general-purpose programmable processor, and can receive data and instructions from the storage system, at least one input device, and at least one output device, and transmitting data and instructions to the storage system, the at least one input device, and the at least one output device.

The program code for implementing the methods of the present disclosure may be written in any combination of one or more programming languages. These program codes can be provided to the processor or controller of general-purpose computer, special-purpose computer or other programmable data processing device, so that when the program code is executed by the processor or controller, the functions/operations specified in the flow chart and/or block diagram are implemented. The program code can be completely executed on the machine, partially executed on the machine, partially executed on the machine and partially executed on the remote machine as a separate software package, or completely executed on the remote machine or server.

In the context of the present disclosure, a machine-readable medium may be a tangible medium that may contain or store a program for use by or in combination with an instruction execution system, apparatus, or device. The machine-readable medium can be a machine-readable signal medium or a machine-readable storage medium. Machine readable media may include, but are not limited to, electronic, magnetic, optical, electromagnetic, infrared, or semiconductor systems, apparatuses, or devices, or any suitable combination of the foregoing. More specific examples of machine-readable storage media may include one or more wire based electrical connections, portable computer disks, hard disks, random access memory (RAM), read only memory (ROM), erasable programmable read only memory (EPROM or flash memory), optical fibers, compact disk read only memory (CD-ROM), optical storage devices, magnetic storage devices, or any suitable combination of the above.

In order to provide interaction with users, the systems and techniques described herein can be implemented on a computer with: a display device for displaying information to users (for example, a CRT (cathode ray tube) or LCD (liquid crystal display) monitor) and a keyboard and a pointing device (e.g., a mouse or a trackball) through which the user can provide input to the computer. Other kinds of devices can also be used to provide interaction with users. For example, the feedback provided to the user may be any form of sensor feedback (e.g., visual feedback, auditory feedback, or tactile feedback); and the input from the user can be received in any form (including acoustic input, voice input or tactile input).

The systems and techniques described herein may be implemented in a computing system including background components (e.g., as a data server), or a computing system including middleware components (e.g., an application server) or a computing system including a front-end component (e.g., a user computer with a graphical user interface or a web browser through which a user can interact with embodiments of the systems and techniques described herein), or a computing system including any combination of the back-end component, the middleware component, the front-end component. The components of the system can be interconnected by digital data communication (e.g., communication network) in any form or medium. Examples of communication networks include local area networks (LANs), wide area networks (WANs), and the Internet.

A computer system may include a client and a server. The client and the server are generally far away from each other and usually interact through communication networks. The relationship between the client and the server is generated by computer programs running on the corresponding computers and having a client server relationship with each other. The server can be a cloud server, a distributed system server, or a blockchain server.

It should be understood that various forms of processes shown above can be used to reorder, add or delete steps. For example, the steps recorded in the present disclosure can be performed in parallel, in sequence, or in different orders, as long as the desired results of the technical solution of the present disclosure can be achieved, which is not limited herein.

The above specific embodiments do not constitute restrictions on the scope of the present disclosure. Those skilled in the art should understand that various modifications, combinations, sub combinations and substitutions can be made according to design requirements and other factors. Any modification, equivalent replacement and improvement made within the spirit and principles of this disclosure shall be included in the scope of protection of this disclosure.

What is claimed is:

1. A method for training a video recognition model, comprising:
dividing a sample video into a plurality of sample video segments, wherein the sample video is labeled with a tag of a true category;
sampling a part of sample video frames from a sample video segment of the plurality of sample video segments;
inputting the part of sample video frames into a feature extraction network to obtain feature information of the sample video segment;
performing a convolution fusion on the feature information by using a dynamic segment fusion module to obtain fusion feature information, wherein a convolution kernel of the dynamic segment fusion module varies with different video inputs;
inputting the fusion feature information to a fully connected layer to obtain an estimated category of the sample video; and
performing a parameter adjustment based on a difference between the tag of the true category and the estimated category to obtain the video recognition model.

2. The method according to claim 1, wherein performing the convolution fusion on the feature information by using the dynamic segment fusion module to obtain the fusion feature information comprises:
dividing the feature information into first feature information and second feature information in a channel dimension;
determining a convolution kernel corresponding to the sample video using a convolution kernel generation branch network;
performing convolution on the first feature information by using the convolution kernel corresponding to the sample video to obtain a convolution result; and
splicing the convolution result with the second feature information to obtain the fusion feature information.

3. The method according to claim 2, wherein the dividing the feature information into the first feature information and the second feature information in the channel dimension comprises:
dividing the feature information into the first feature information and the second feature information in the channel dimension according to a pre-set hyper-parameter β, wherein the channel dimension of the first feature information is βC, the channel dimension of the second feature information is (1−β)C, and C is the channel dimension of the feature information.

4. The method according to claim 3, wherein the determining the convolution kernel corresponding to the sample video using the convolution kernel generation branch network comprises:
calculating a product of the channel dimension βC of the first feature information, a number of the plurality of sample video segments, a number of the part of sample video frames of the sample video segment, and a height and a width of the sample video frames; and
inputting the product to the convolution kernel generation branch network to obtain the convolution kernel corresponding to the sample video.

5. The method according to claim 2, wherein the convolution kernel generation branch network comprises a global average pooling layer and two fully connected layers.

6. The method according to claim 1, wherein the dynamic segment fusion module comprises at least one dynamic segment fusion module, the video recognition model comprises the at least one dynamic segment fusion module and a plurality of residual layers, and the at least one dynamic segment fusion module is arranged in the plurality of residual layers and at an interval of a residual layer.

7. The method according to claim 1, wherein dividing the sample video into the plurality of sample video segments comprises:
evenly dividing the sample video according to a length of the sample video to obtain the plurality of sample video segments,
wherein sampling the part of sample video frames from the sample video segment comprises:
sampling video frames from the sample video segment at equal intervals to obtain the part of sample video frames.

8. The method according to claim 1, wherein the performing the parameter adjustment based on the difference between the tag of the true category and the estimated category to obtain the video recognition model comprises:
calculating a cross entropy loss based on the tag of the true category and the estimated category; and
optimizing the cross entropy loss by using a stochastic gradient descent and continuously updating parameters until the cross entropy loss converges to obtain the video recognition model.

9. The method according to claim 1, comprising:
acquiring a to-be-recognized video;
dividing the to-be-recognized video into a plurality of to-be-recognized video segments;
sampling a part of to-be-recognized video frames from a to-be-recognized video segment; and
inputting the part of to-be-recognized video frames into the video recognition model to obtain a category of the to-be-recognized video.

10. The method according to claim 9, wherein a dividing granularity of the to-be-recognized video is greater than a dividing granularity of the sample video used to train the video recognition model.

11. An electronic device comprising:
one or more processors; and
a storage device in communication with one or more processor, wherein the storage device stores instructions executable by the one or more processor, to cause the one or more processor to perform operations comprising:
dividing a sample video into a plurality of sample video segments, wherein the sample video is labeled with a tag of a true category;
sampling a part of sample video frames from a sample video segment of the plurality of sample video segments;
inputting the part of sample video frames into a feature extraction network to obtain feature information of the sample video segment;
performing a convolution fusion on the feature information by using a dynamic segment fusion module to obtain fusion feature information, wherein a convolution kernel of the dynamic segment fusion module varies with different video inputs;
inputting the fusion feature information to a fully connected layer to obtain an estimated category of the sample video; and
performing a parameter adjustment based on a difference between the tag of the true category and the estimated category to obtain a video recognition model.

12. The electronic device according to claim 11, wherein performing the convolution fusion on the feature information by using the dynamic segment fusion module to obtain the fusion feature information comprises:
dividing the feature information into first feature information and second feature information in a channel dimension;
determining a convolution kernel corresponding to the sample video using a convolution kernel generation branch network;
performing convolution on the first feature information by using the convolution kernel corresponding to the sample video to obtain a convolution result; and
splicing the convolution result with the second feature information to obtain the fusion feature information.

13. The electronic device according to claim 12, wherein the dividing the feature information into the first feature information and the second feature information in the channel dimension comprises:
dividing the feature information into the first feature information and the second feature information in the channel dimension according to a pre-set hyper-parameter β, wherein the channel dimension of the first feature information is βC, the channel dimension of the second feature information is (1−β)C, and C is the channel dimension of the feature information.

14. The electronic device according to claim 13, wherein the determining the convolution kernel corresponding to the sample video using the convolution kernel generation branch network comprises:
calculating a product of the channel dimension βC of the first feature information, a number of the plurality of sample video segments, a number of the part of sample video frames of the sample video segment, and a height and a width of the sample video frames; and
inputting the product to the convolution kernel generation branch network to obtain the convolution kernel corresponding to the sample video.

15. The electronic device according to claim 12, wherein the convolution kernel generation branch network comprises a global average pooling layer and two fully connected layers.

16. The electronic device according to claim 11, wherein the dynamic segment fusion module comprises at least one dynamic segment fusion module, the video recognition model comprises the at least one dynamic segment fusion module and a plurality of residual layers, and the at least one dynamic segment fusion module is arranged in the plurality of residual layers and at an interval of a residual layer.

17. The electronic device according to claim 11, wherein the dividing the sample video into the plurality of sample video segments comprises:
evenly dividing the sample video according to a length of the sample video to obtain the plurality of sample video segments,
wherein sampling the part of sample video frames from the sample video segment comprises:
sampling video frames from the sample video segment at equal intervals to obtain the part of sample video frames.

18. The electronic device according to claim 11, wherein the performing the parameter adjustment based on the difference between the tag of the true category and the estimated category to obtain the video recognition model comprises:
calculating a cross entropy loss based on the tag of the true category and the estimated category; and
optimizing the cross entropy loss by using a stochastic gradient descent and continuously updating parameters until the cross entropy loss converges to obtain the video recognition model.

19. The electronic device according to claim 11, comprising:
acquiring a to-be-recognized video;
dividing the to-be-recognized video into a plurality of to-be-recognized video segments;
sampling a part of to-be-recognized video frames from a to-be-recognized video segment; and
inputting the part of to-be-recognized video frames into the video recognition model to obtain a category of the to-be-recognized video.

20. A non-transitory computer readable storage medium, storing a computer instruction, wherein the computer instruction when executed by a computer causes the computer to perform operations comprising:
dividing a sample video into a plurality of sample video segments, wherein the sample video is labeled with a tag of a true category;
sampling a part of sample video frames from a sample video segment of the plurality of sample video segments;
inputting the part of sample video frames into a feature extraction network to obtain feature information of the sample video segment;
performing convolution fusion on the feature information by using a dynamic segment fusion module to obtain fusion feature information, wherein a convolution kernel of the dynamic segment fusion module varies with different video inputs;
inputting the fusion feature information to a fully connected layer to obtain an estimated category of the sample video; and
performing a parameter adjustment based on a difference between the tag of the true category and the estimated category to obtain a video recognition model.
